(19) United States
(12) Patent Application Publication
(10) Pub. No.: US 2002/0120674 A1
(43) Pub. Date: Aug. 29, 2002

(54) System and method for web presentation utilizing voice, voice-over, text, streaming images and escorted browsing, in real time

(76) Inventors: Jay Son, Fremont, CA (US); Wei Yan, Albany, CA (US)

Correspondence Address: OPPENHEIMER WOLFF & DONNELLY, P. O. BOX 10356, PALO ALTO, CA, 94303, US

(21) Appl. No.: 10/085,828

(22) Filed: Feb. 27, 2002

Related U.S. Application Data
(60) Provisional application No. 60/272,256, filed on Feb. 27, 2001.

(51) Int. Cl. G06F 15/16

(52) U.S. Cl. 709/202

(57) ABSTRACT

A method of providing a real time interactive environment, over the Internet, between an agent of an online retailer and a client, comprising, creating images of a product of the online retailer, the images including at least one of a panorama view image, a 3-D movie and a magnified image frame, providing a call center services for real time, bi-directional communication between the agent and the client, combining the product image with recorded voiceover, the voiceover further describing the product, providing means by which the agent can push onto the client computer an alternative product, wherein the agent and the client view the alternative product simultaneously, providing means for the retailer to receive client input, and providing a web server for hosting the created image of the product of interest and hosting the call center.

### RELATED APPLICATIONS

The present application is related to and claims priority from U.S. provisional Application No. 60/272,256 entitled “SYSTEM AND METHOD FOR INSTANT, SIMULTANEOUS INTERACTION BETWEEN CLIENTS AND AGENTS OVER THE INTERNET, UTILIZING VOICE, VOICE-OVER, TEXT, STREAMING IMAGES AND ESCORTED BROWSING, IN REAL TIME”, filed on Feb. 27, 2001.

### TECHNICAL FIELD

The present invention relates generally to a browser-based telecommunications network such as the Internet, and more particularly, to a system and method for presenting products and managing interaction between client and agents in the browser-based telecommunications network.

### BACKGROUND ART

Despite the advances of the Internet over the past years, Web based systems are still unable to provide a realistic, life like interactive environment for a client and service provider. In a real retail environment, the client can inspect the product, look at it from different angles, and simultaneously ask questions of a salesperson helping him or her out about the product. The salesperson can suggest other products that may satisfy the need of the client. It is desirable to provide this realistic interactive environment to mimic the real life experience of a client as closely as possible.

Various systems have approached this problem from different angles. Some systems have focused on providing a voice communication over the Internet. However, existing systems are of poor quality, and do not allow for simultaneous, clear bi-directional transmission. No existing system has combined voice technology with still and streaming images in addition to text interactivity, in the context of providing a realistic interactive environment, providing a closely realistic experience.

Therefore, it is desirable to provide an improved method and system capable of supporting online sales, business transactions, conferences and educational settings, wherein the user experience is improved, both in terms of customer service and in terms of communication technology.

These and other objects and advantages of the present invention will become clear to those skilled in the art in view of the description of the best presently known mode of carrying out the invention and the industrial applicability of the preferred embodiment as described herein and as illustrated in the several figures of the drawings.

### DISCLOSURE OF INVENTION

It is a primary objective of the present invention to provide an improved method and system of providing a turnkey operation that allows an online interactive communication system with simultaneous access to images, wherein the images may include one or more of the following features: voiceover recording, embedded text, panorama view, 3-D movie images, magnified view images, and 3-D virtual model images, and wherein communication is provided via at least one of voice over Internet Protocol (VoIP), voice chat, text chat, email and group chat.

Another object of the present invention is to provide for a method and system of creating an online interactive system allowing for simultaneous viewing of images and a communication system allowing for real time live customer support.

Yet another object of the present invention is to provide for a system and method of creating panorama images of products to be hosted on a web site and downloadable without the need for a plug-in, wherein the image may include voiceover recording, embedded text, magnified view, and a communication control panel for communicating with a live agent.

Yet another object of the present invention is to provide for a system and method of creating 3-D movie images of products to be hosted on a web site and downloadable without the need for a plug-in, wherein the image may include voiceover recording, embedded text, magnified view, and a communication control panel for communicating with a live agent.

Yet another object of the present invention is to provide for a system and method of creating magnified view images of products to be hosted on a web site and downloadable without the need for a plug-in, wherein the image may include voiceover recording, embedded text, and a communication control panel for communicating with a live agent.

Briefly, one embodiment of the present invention comprises of a method of providing a real time interactive environment, over the Internet, between an agent of an online retailer and a client, comprising, creating images of a product of the online retailer, the images including at least one of a panorama view image, a 3-D movie and a magnified image frame, providing a call center services for real time, bi-directional communication between the agent and the client, combining the product image with recorded voiceover, the voiceover further describing the product, providing means by which the agent can push onto the client computer an alternative product, wherein the agent and the client view the alternative product simultaneously, providing means for the retailer to receive client input, and providing a web server for hosting the created image of the product of interest and hosting the call center.

Yet another aspect of the present invention is embodied in a method of providing a real time interactive environment, over the Internet, between an agent and a client, comprising, creating images of a product, the images including at least one of a panorama view image, a 3-D movie and a magnified image frame, providing a call center services for real time, bi-directional communication between the agent and the client, combining the product image with recorded voiceover, the voiceover further describing the product, providing means by which the agent can push onto the client computer an alternative product, wherein the agent and the client view the alternative product simultaneously, and providing means for receiving client input.

Yet another aspect of the present invention is embodied in a method for creating a panorama image comprising, obtaining digital photos from an image source, stitching digital photos to create a panorama image, resizing, cutting and/or cropping the image, adjusting the image for contrast and brightness, compressing the panorama image, recording voiceover related to the panorama image, and associating the panorama image with a call center module, wherein the call center provides bi-directional, real time communication between an agent and a client viewing the panorama image.

Yet another aspect of the present invention is embodied in a method of creating a 3-D movie comprising, obtaining a plurality of digital photos from an image source, combining the plurality of digital photos to create a 3-D movie, resizing, cutting and/or cropping the image, adjusting the image for contrast and brightness, compressing the 3-D movie, recording voiceover related to at least one frame of the 3-D movie, and associating the 3-D movie with a call center module, wherein the call center provides bi-directional, real time communication between an agent and a client viewing the 3-D movie.

Yet another aspect of the present invention is embodied in a method of creating a magnified view of an image frame comprising, obtaining a digital photo from an image source corresponding to a selected image frame, obtaining a user input defining a background image size and a magnified image size, creating a magnified image corresponding to the selected image frame, resizing, cutting and/or cropping the image, adjusting the image for contrast and brightness, compressing the magnified image file, combining the selected image frame with recorded voiceover, and associating the selected image with a call center module, wherein the call center provides bi-directional, real time communication between an agent and a client viewing the selected image frame.

These and other objects and advantages of the present invention will no doubt become apparent to those skilled in the art after having read the following detailed description of preferred embodiments which are illustrated in the several figures of the drawing.

### BRIEF DESCRIPTION OF THE DRAWINGS

FIG. 1 is a flow diagram illustrating the operation of the overall system;

FIG. 2 illustrates one embodiment of the physical system implementing the system of the present invention;

FIG. 3 is a screen shot of an illustrative example of a web page interface viewed by clients;

FIG. 4 illustrates a flow diagram for panorama builder/3-D movie and magnifier modules according to one embodiment of the present invention;

FIG. 5A illustrates a flow diagram of the panorama builder module according to one embodiment of the panorama module;

FIG. 5B illustrates the continuation of the flow diagram of the panorama builder module according to one embodiment of the panorama module;

FIG. 6 illustrates a flow diagram of one embodiment of a panorama viewer module;

FIG. 7A illustrates a flow diagram of the 3-D movie builder module according to one embodiment of the present invention;

FIG. 7B illustrates the continuation of the flow diagram of the 3-D movie builder module according to one embodiment of the present invention;

FIG. 8 illustrates a flow diagram of one embodiment of a 3-D movie viewer module;

FIG. 9A illustrates a flow diagram of the magnifier builder module according to one embodiment of the present invention;

FIG. 9B illustrates the continuation of the flow diagram of the magnifier builder module, according to one embodiment of the present invention; and

FIG. 10 illustrates a flow diagram of one embodiment of a magnifier viewer module.

### BRIEF DESCRIPTION OF THE DRAWINGS

The application of the innovative methods and systems of the present invention in providing an interactive environments is possible in various settings. For example, in one embodiment the method and system of the present invention may be used in providing a more intuitive and interactive sales environment, where the client gets a better feel for a product by seeing it from various angles, seeing it in a magnified view, and is able to read and hear embedded text and voiceover recordings providing specific product information. Furthermore, the client may select from a host of communication means to contact a live agent for further assistance. The client and the agent look at the same objects and the same views, so the agent is able to assist the client as if he was with the client. Furthermore, while communicating to the client, the agent may send to alternative choices to the client, based on the clients requirements.

In an alternative embodiment, the present invention may be used to provide an interactive environment, wherein students and teachers may interact in live environment, while all are looking and manipulating the same thing. The various modes of presentation of a particular thing under study as well as multiple communication methods allow for a more realistic interactive environment, suitable to other kinds of scenarios such as business transactions, conferences and online classrooms. The details of the implementation of the present invention are herein described.

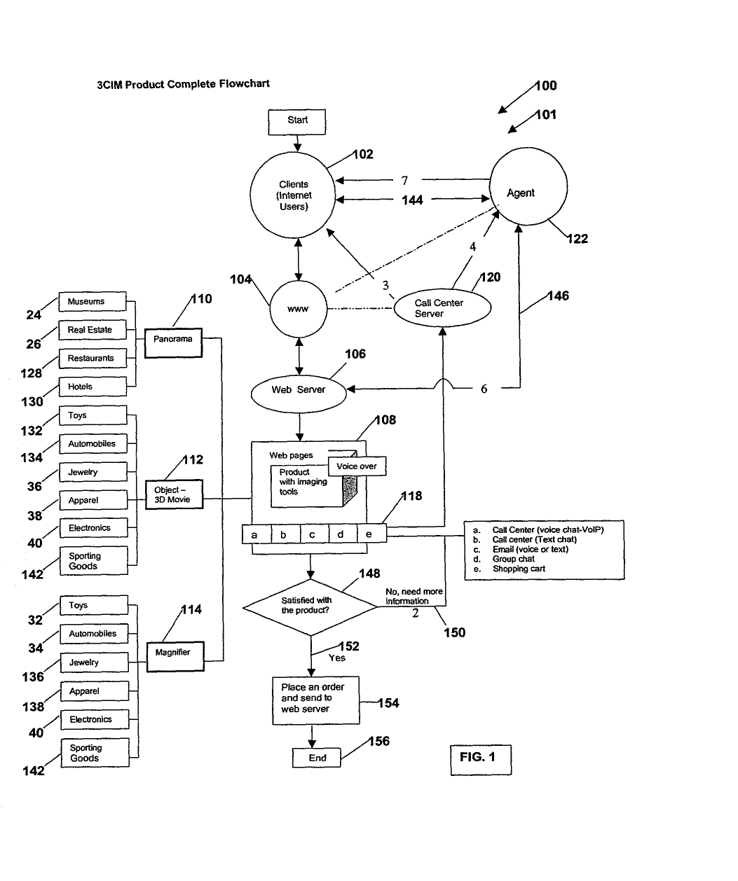

FIG. 1 is a flow diagram illustrating the operation of the overall system. The process 100 starts when client(s) 102 connects to the system of the present invention through the world wide web (www) 104, by connecting to the system web server 106. In an exemplary embodiment of the system of the present invention, once a client 102 connects to the system web server 106, he may select particular products from a list or a catalog. The selection of a particular product would trigger other web pages that contain different views of the selected product including a panorama view 110, or an 3-D movie 112 (3-dimensional 3-D), or a magnifier view 114.

Before or after selecting a particular product, the client 102 has available to him/her a plurality of options 118a-e, including communication with an agent 122 through a call center 120 via voice chat 118a (Voice over Internet Protocol (VoIP)), text chat 118b, and email 118c (voice or text). Alternatively, clients 102 may elect to use a group chat option 118d and communicate with other client), or make a purchase of a selected product by choosing the shopping cart 118e.

The system of the present invention may be used in many different context, such as presentation of products for sales, presentation of real estate, hotel and restaurants, providing an interactive environment for education use and other such interactive uses where clients 102 and the system interact. So once a client 102 downloads the web page by connecting to the system web server 106, he or she may select a particular product to view. In an exemplary embodiment, the client selection is made from a web page where the plurality of available products choice are presented to the client through a plurality of thumbnails. A thumbnail as used herein refers to a small photo or icon representing a product or a choice of product. The user may select the particular product by moving his cursor over the thumbnail and select that product. Once the selection of a product is registered, the thumbnail may act as a link to the web page or a Uniform Resource Locator (URL) where the file corresponding to a particular view of the selected product is located. The files and web pages containing specific views of a selected product may be created using product imaging tools available in the system of the present invention. The designer may elect to have a single view linked to a particular product. Alternatively, multiple views of a product may be available and clients 102 may select among the alternate views.

For example, the client 102 may elect to see a panorama view 110 of a selected objected, or an object view 112 allowing for a 3-D viewing of the product, or use a magnifier view 114 to see a magnified view of the particular object. Alternatively, a first view of a product is automatically presented to clients when they first elect to view that product, and then the client 102 may select an alternative view, if available. The availability of a particular view for a selected product may be due to practical design decisions by the system designer based on various criteria including the size of the files to be downloaded to by the client 102, and the download speed of the network.

FIG. 1 shows a sample of possible products that may benefit from the type offered by the system of the present invention. For example, the panorama view 110 may be used in realistic representation of museums 124, real estate 126 such as homes for rent or sale, restaurants 128 and hotels 130. The panorama view 110 allows the client 102 to observe a panoramic view of up to 360 degrees of the selected premise. The panorama view 110 may be combined with other views such as magnifier view 114 to allow the client 102 to see more detail features of the selected product at a particular portion of the panoramic view.

The 3-D movie view 112 may be used to show features of the selected object by rotating the object in 3-D. As shown in FIG. 1, some examples of products that may be suitable for an 3-D movie view 112 or 3-D movie may be toys 132, automobiles 134, jewelry 136, apparel 138, electronics 140, and sporting goods 142. The magnifier view 114 may be used in conjunction with the 3-D movie view 112 to show a magnified view of at least one frame of the 3-D movie of a selected product. Alternatively, the magnifier view 114 may be used as a stand alone imaging tool used to show the magnified view of a single frame of a selected object, including toys 132, automobiles 134, jewelry 136, apparel 138, electronics 140, and sporting goods 142.

The panorama view 110, the 3-D movie view 112 or the magnifier view 114 may be created using imaging tools that are an integral part of the system or stand alone modules. The imaging tools are used to create files that store data corresponding to each of the different views of a selected product. Once a client selects a particular product, the product is displayed in a pre-selected view, either the panorama view 110, the 3-D movie view 112 or the magnifier view 114.

Returning to FIG. 1, when the user connects to the system web server 106 and is selecting options from one of the web pages 108, he may select to view a product, or alternatively select one of the communication options 118a-118e to connect through the call center 120 to a customer representative or agent 122. Alternatively, the client 102 may elect to communicate with an available agent after having viewed all of the selected product, and when he still is in need of more information and assistance. In a presently preferred embodiment, the communication options are always available to clients 102, whenever they require assistance. Upon the client's selection of a particular communication option 118a-118e, the call center 120 determines the next available agent 122 and establishes a communication path 144 between the agent 122 and the requesting client 102. The system web server 106 and the agent 122 are also connected and communicate (link 146), allowing the agent 122 to receive client 102 specific information such as the client records and purchase history, as well as the product the client 102 is currently looking at. In one example, the agent 122 sees the same item from the same view as the client 102 and may provide the client assistance by providing alternative suitable products. The agent 122 provides the alternatives by using a push technology and forwarding the selected product data and available views to the client using push technology. Since both the client 102 and the agent 122 are looking at the same product, they can interact and the agent 122 may respond to the client's 102 questions as if both were in the same physical location.

Client 102 may choose the shopping cart option 118e, and the system would ask the client 102 if he or she is satisfied with the selected product. If the client 102 is not satisfied with the product (link 150), the client 102 may be connected with an available agent 122, via a client 102 selected communication means 118a-118e. If the client 102 is satisfied with the selected product (link 152), he or she may directly place an order 154 through the system or place an order through the agent 122 that is helping the client 102. The client 102 may exit the process at any point in the process 100 by ending its connection at 156.

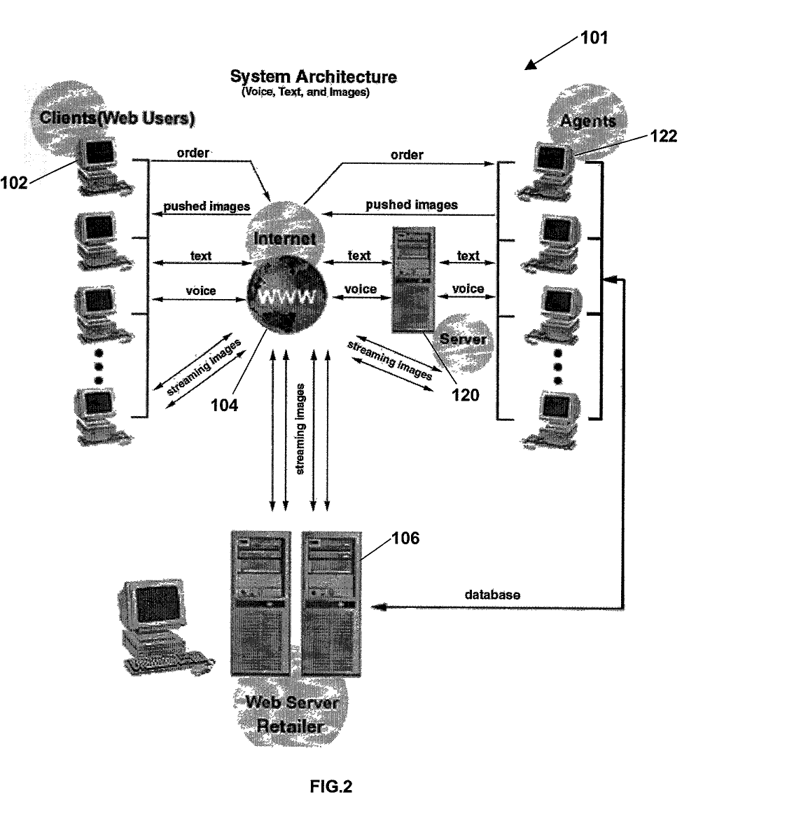

FIG.2 illustrates an implementation of a system architecture according to one embodiment of the present invention. A simplified architecture of a system 101 according to one embodiment of the present invention includes a plurality of clients 102, the world wide web 104, a plurality of system web servers 106, a call center server 120, and a plurality of agents 122. Clients 102 connect through the World Wide Web 104, to at the plurality of system web server 106 hosting the web pages 108 (see FIG. 1). The web pages 108 provide a user interface for the clients 102 to interact with the system 101 and select one a plurality of communication options to contact live agents 122 who could further assist the clients 102 in their system 101 related activities. The call center server 120 creates the communication link between the clients 102 and the agents 122 based on the clients selected means of communication. The means of communication between the clients 102 and the agents 122 may include “text” as in text chat and email, as well as “voice” as in Voice over IP. Furthermore, both the clients 102 and the agents 122 may obtain still or streaming images transmitted by the system web servers 106, including panorama view and 3-D movies showing client selected or agents recommended products in a more realistic representation.

The agents 122 can further assist the clients 102 by recommending products. The process of product recommendation may include pushed images that represent the recommended product. Product representation may include one or more of a panorama view, an 3-D movie, a magnified view, text imbedded and voice embedded real photos of the product, providing as much information as possible in a user friendly and intuitive manner, closely resembling the experience of face to face interaction between a sales person and a client.

Once the client 102 is satisfied with the product, he may elect to purchase the product by directly placing his order through the World Wide Web 104 to the system web servers 106 or ask the agent 122 to register his order.

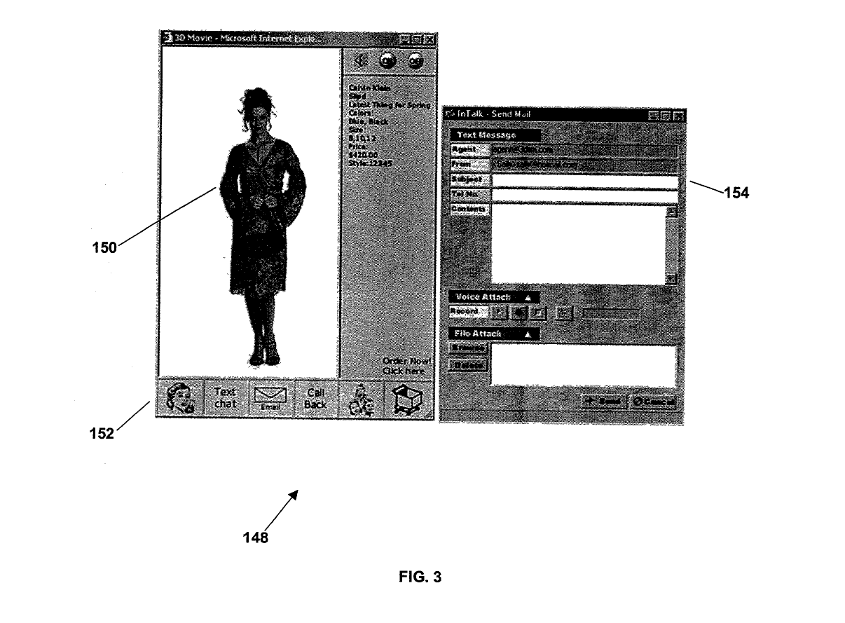

FIG. 3 is a screen shot of an illustrative example of a web page interface viewed by clients. The graphical user interface (GUI) 148 may include a photograph 150 of the product for sale, in this case a dress (worn by the model seen in the photograph), a graphical interface 152 presenting the choices 118a-118e (see FIG. 1), and a chat interface 154. In the present example, the photograph 150 may itself be a GUI activated by the user when he or she moves his cursor on the image and clicks. This selection may activate an 3-D movie 112 (see FIG. 1) that would allow the viewing of the product from 360 degrees, or in different poses. Although not shown here, the photograph 150 may also include embedded text and voice over presenting more information to the client 102.

The client 102 (see FIG. 1) may select a communication means 118a-118e by selecting one of the buttons of the GUI 152. Based on the selected communication means 118a-118e, another GUI 154 window may open to allow the client 102 to interface with an available agent 120 (see FIG. 1).

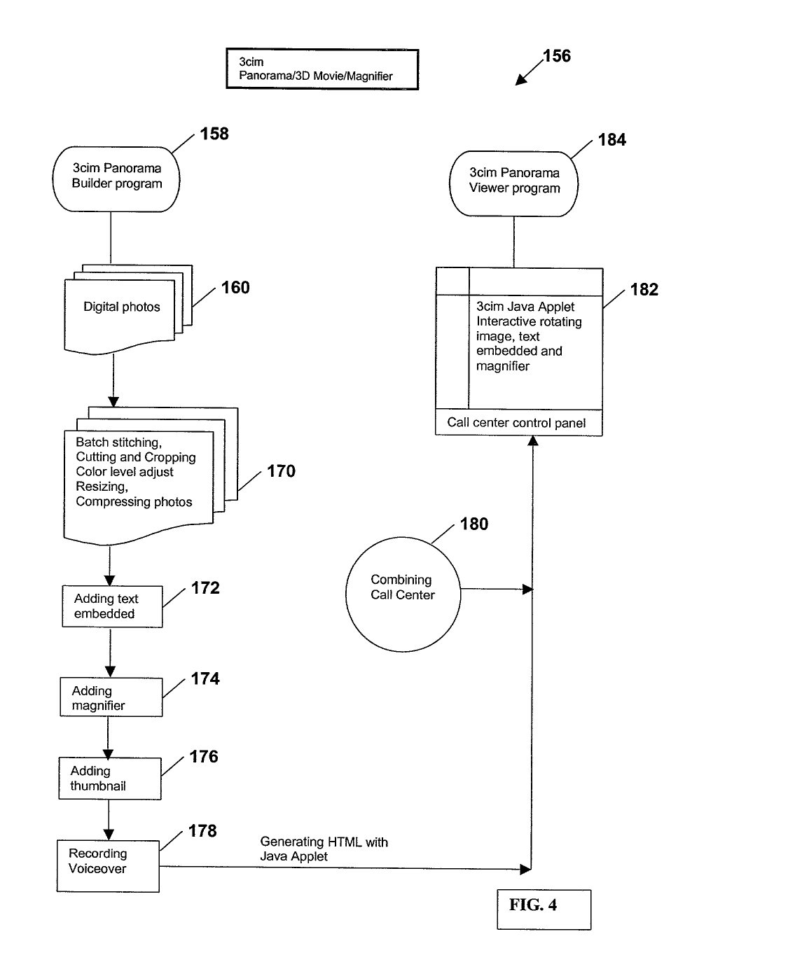

FIG. 4 illustrates a flow diagram for panorama builder module according to one embodiment of the present invention. Although the flow diagram 156 of the panorama builder 158 will be described herein, the operation of a 3-D movie builder module or a magnifier builder module, the panorama builder module 158 are similar at the level of this flow diagram and therefore one skilled in the art would understand that the general principles described in FIG. 4 would be equally applicable to the 3-D movie builder module or the magnifier builder module.

The operation of the panorama builder module 158 starts with a series of digital photos 160 that are manipulated to create the desired panorama view. The operations 170 performed on the digital photos may include orienting the individual photos, batch stitching the photos together, resizing the stitched photos, color level adjustment including brightness and contrast adjustments of the stitched photos, cutting and cropping of the images, and compression of the stitched and adjusted photo.

In step 172, once the photo file is created, the panorama builder may be used to add embedded text to various parts of the stitched and compressed panorama photo. In step 174, a magnifier may be used to add more detail as desired to particular parts of the panorama view. In step 176, a thumbnail may be created using at least a part of the panorama view. In step 178, the panorama builder module 158 may be used to record voice over parts of the panoramic view. When a client 102 (see FIG. 1) connects to the system of the present invention, he or she selects a product to view. The selection of the product triggers the generation of HTML files including Java applets. In step 180, the call center features are created and linked to the panorama view created. This allows the user to perform access the call center features while viewing the presentation in its panoramic view. The presentation file 182 is a represents a completed panorama view file created, including the stitching, embedding of text and voiceover, adding the magnifier, creating a thumbnail and adding the call center control panel 152 (see FIG. 3) and linking the call center features. Once the panorama view file 182 has been created, a client 102 may view the selected product in a panorama view and navigate within the panorama view using a panorama viewer program 184.

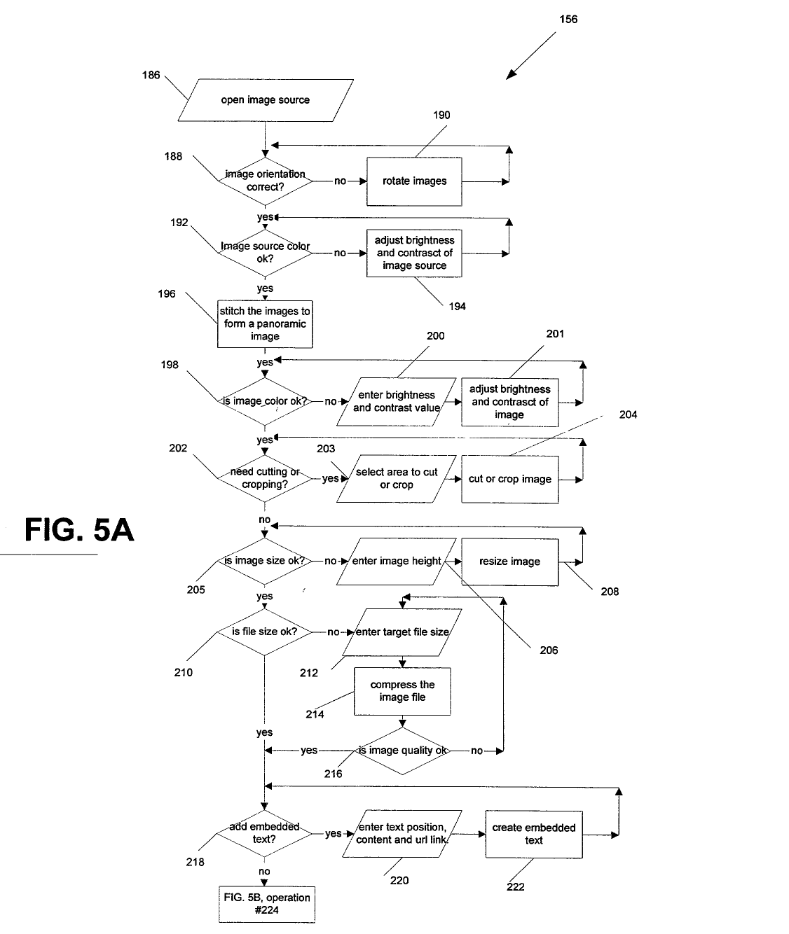

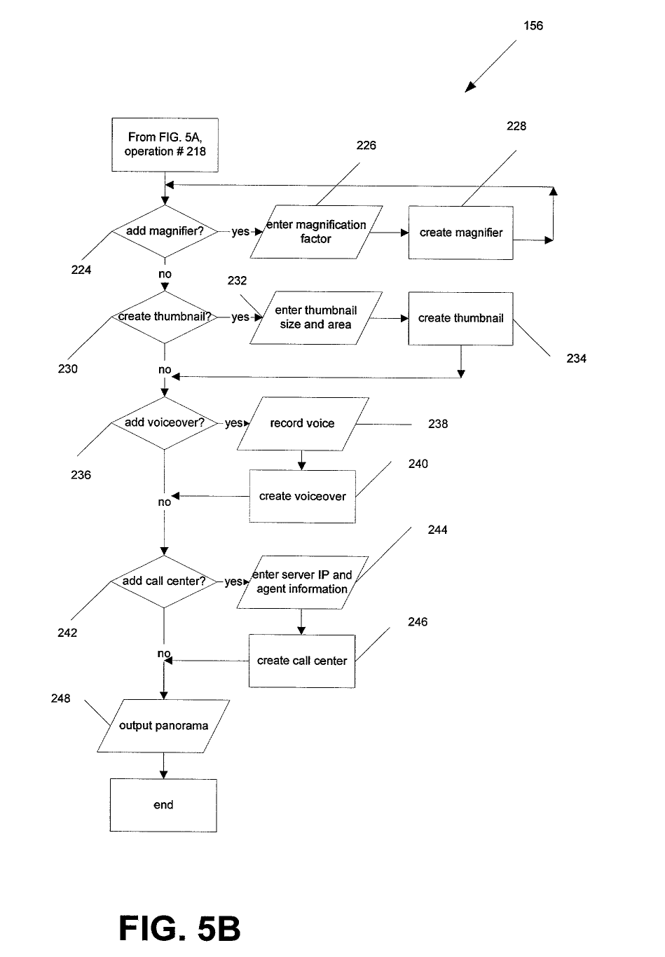

FIG. 5A illustrates a flow diagram of the panorama builder module according to one embodiment of the present invention. The panorama builder module 156 is used to create panoramic view images. The user interface of the panorama builder module described herein acts as the front-end interface to a stitching and panorama view creating program. There are several commercially available photo-stitching programs. The general functions and features of the various stitching programs are very similar. It would be apparent to one skilled in the art that the user interface described herein may have to be modified to accommodate differences between various stitching programs.

The operation of the panorama builder 156 starts with opening an image source in step 186. The image source may be created in a plurality of ways. The images may be scanned into a computer and converted into digital format or they may be created and directly downloaded from a digital camera.

In step 188, the user is given the option of changing and readjusting the orientation of the digital images step 190. In step 192, the user may adjust the image color. If the user decides to change the image color, he may do so in step 194. The image color adjustment may include adjusting the image for brightness and contrast. The user may continue readjusting the image and viewing it until he is satisfied with the color.

In step 196, the individual images within the image source are stitched together to form a panorama view. The user would have to let the system know if the stitched image is a 360 degrees image, which would require the two end images to be stitched together. In the current embodiment, each image being stitched has to have at least ten percent and a maximum of ninety percent overlap. Furthermore, the user may eliminate from stitching, images that are substantially duplicated, in order to create a smaller file to work with.

The user may elect to change image color in step 198. If the user elects to change image color, he may do so in step 200 by entering a desired value for brightness and contrast. The panorama builder module 156 then adjusts the panorama view images brightness and contrast in step 201 and presents the adjusted image to the user for his acceptance, in step 198. This operation performs an image color adjustment on the entire stitched image, as opposed to operation 194 which performs a color adjustment on individual image frames in the image source.

In operation 202, the user may delete portions of the image by cutting and cropping. Cutting allows the user to select an area to be deleted and cut that area from the panorama view. Cropping would allow the user to define a border above or below which the image is cutoff. Cutting or cropping is done by selecting an area to cut or crop in step 203. The system next cuts or crops the selected area and creates the image in operation 204. The user is given the option of accepting or rejecting the changes in operation 202.

In step 205, the user is given the option of adjusting the image size. If the user elects to change the image size, he may enter a desired image height in step 206. The panorama builder module then resizes the image in step 208 and the system asks the user in step 198 if the resized image is acceptable.

In step 210, the user has the option of changing the panorama image file size. If the user selects this option, the panorama builder module 156 would prompt him to enter a target file size in operation 212. A smaller the file size allows for faster download speeds by the client 102. The panorama builder module 156 then proceeds to attempt to compress the image file to the user defined desired size, in operation 214. If the desired reduction in the file size is not possible, the system would compress the file to the extent possible and ask the user to approve the file size. Alternatively, the system may inform the user that the desired file size reduction is not possible and request the user to enter a new value for the file size reduction. The reduction of the file size by compression results in image quality degradation. In operation 216, the panorama builder module 156 prompts the user to decide on the quality of the image. If the user is dissatisfied with the image quality, he may enter a new target file size value by repeating the operations 210 through 216.

If the user is satisfied with the quality of the image after the file size reduction, the user may elect to add embedded text to the image in operation 218. Upon this selection, the panorama builder module 156 prompts the user to enter a text position, content and URL link for the embedded text in operation 220. The panorama builder module 156 then proceeds to create the embedded text in operation 222. Operations 218-222 are repeated until the user has input all the embedded text he desires. Additional features of the panorama builder module 156 are described in FIG. 5B.

FIG. 5B illustrates the continuation of the flow diagram of the panorama builder module according to one embodiment of the panorama module. As shown in FIG. 5A of flow diagram of one embodiment of the panorama builder module 156, after deciding on the option to create add embedded text, in operation 218, the user may elect to add a magnified images to selected parts of the panorama image in operation 224.

In operation 224, the user may elect to add magnifier features to the image. If the user makes this election, he may enter a magnification factor in step 226. The panorama builder module 156 uses this magnification factor to create a magnifier. A magnifier as used herein refers to creating a magnified image of a user-selected area of the larger panorama image. Operations 224 through 228 may be repeated if the user elects to add more magnifying views. The magnifier in a panorama view helps show every detail of the scene. While clients can look around the panorama, they also can interactively move the magnifier to see anywhere they like. The size and scale of the magnifier can be controlled through the HTML page's Java applet parameters.

In operation 230, the user may elect to create a thumbnail. A thumbnail as used herein refers to a small image created to represent the entire panorama image or a part of it. The thumbnail may be used in a catalog display by showing the actual view presented to the client if he selects that particular thumbnail. In operation 232, if the user elects to create a thumbnail, he may enter the values for the size and the area of panorama image to be included in the thumbnail. In operation 234 the panorama builder module 156 creates the thumbnail.

In operation 236, the user may elect to add voice over to the panorama image. If the user decides to add voiceover to the panorama image, he can input the voiceover by recording it in operation 238. In operation 240, the panorama builder module 156 proceeds to create the voiceover.

In operation 242, the user may elect to add call center features to the panorama image. If the user elects to call center features to the panorama image, he may enter the agent information including the Internet address or IP address of the server that is connecting that agent or group of agents to the Internet and ultimately the clients, in operation 244. In operation 246, the panorama builder module 156 creates call center. This step includes adding the call center control bar 152 as described in FIG. 3. The process of creating a panorama image is completed in operation 248 by outputting a panorama view file. The file may include a series of HTML files, JPG image files with embedded Java Applets. In one embodiment of the present invention, the panorama view file is stored on a the user's file server, and the user provided services include creating the panorama view as well as hosting the web site and the files for a third party customer. The potential clients 102 would be accessing the servers of the service provider that has created the panorama view to access the information and images residing therein.

In an alternative embodiment, the panorama builder module 156 may be used as a stand alone module that allows any user to create panorama view files that may be stored on that user's own web site or a third party web site. Thus, the seller of the panorama builder module 156 would not necessarily provide the associated services of hosting the web site of the user and providing associated services such as the call center system 120.

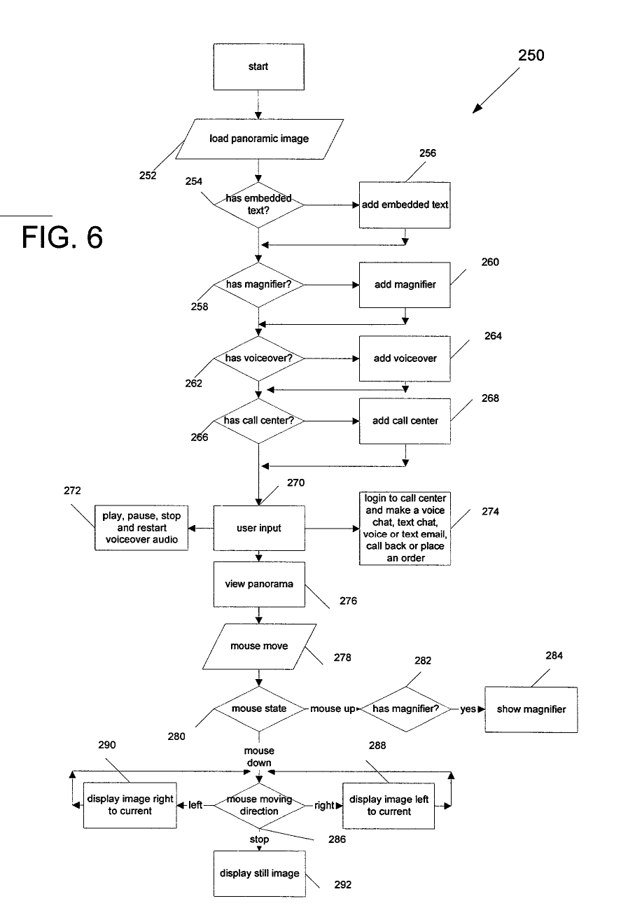

FIG. 6 illustrates a flow diagram of one embodiment of a panorama viewer module. The panorama viewer module 252 is used by clients 102 to view the panorama images created by a panorama builder module 156, and stored on a web site. The operation of the panorama viewer 250 begins with loading the panorama image in operation 252. Once the panorama viewer 250 has loaded the panoramic image, it looks for embedded text features, in operation 254. If embedded text is present, the panorama viewer 250 adds the embedded text. in operation 256.

In operation 258, the panorama viewer 250 checks for the presence of magnified views of the panorama image. If magnified views are present, the panorama viewer 250 adds the partially magnified images on top of the panorama images, in operation 260.

In operation 262, the panorama viewer 250 determines whether the panorama image includes any voiceover. If voiceover is included, the panorama viewer 250 adds voiceover to the image in operation 264.

In operation 266, the panorama viewer 250 determines if call center features were included with the panorama image. In operation 268, the call center features are added to the panorama image.

In operation 270, the panorama viewer 250 determines the user input The user in this case would be the client 102 who are using the panorama viewer 250 to view panorama images stored on a server. In operation 274, based on the client input, the panorama viewer 250 may login to the call center to connect the client user to an agent 122 via a client selected means of communication. In operation 272, the panorama viewer 250 may play, pause, stop and restart the voiceover recording based on the client input.

In operation 276, the panorama image is presented to the client based on his input. In operation 278, the client mouse moves are obtained. In operation 280, based on the current mouse state 280, the panorama viewer moves the panorama image. In operation 282, if the mouse button is up, and the panorama image has a magnifier (operation 282), the panorama viewer 250 displays the magnified view of the selected area of panorama image, in operation 284.

If the mouse button is down, the panorama viewer 250 determines the mouse moving direction in operation 286. In operation 288, if the mouse moving direction is to the right, the panorama viewer 250 displays the image to the left of the current image. In operation 290, if the mouse moving direction is to the left, the panorama viewer 250 displays the image to the right of the current image. In operation 292, if the mouse stops, the panorama viewer 250 displays a still image.

This intuitive navigation user interface is used to navigate in a panoramic image that may span the full 360 degrees. It would be apparent to one skilled in the art that alternative user interfaces may be used to perform a similar navigation helping to view the panoramic image.

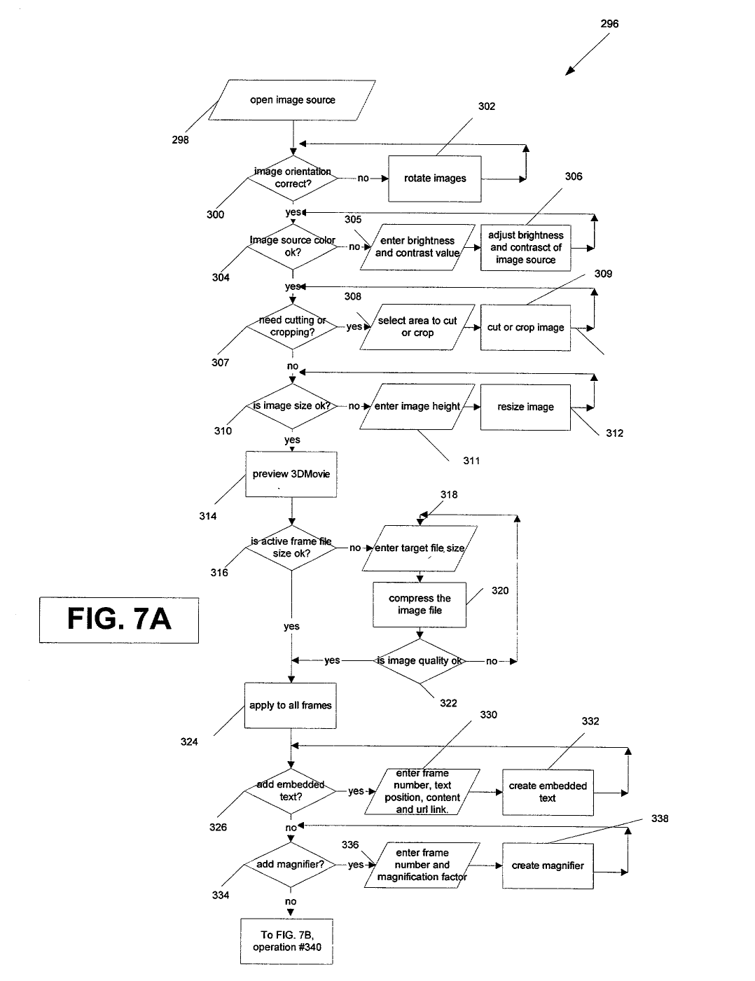

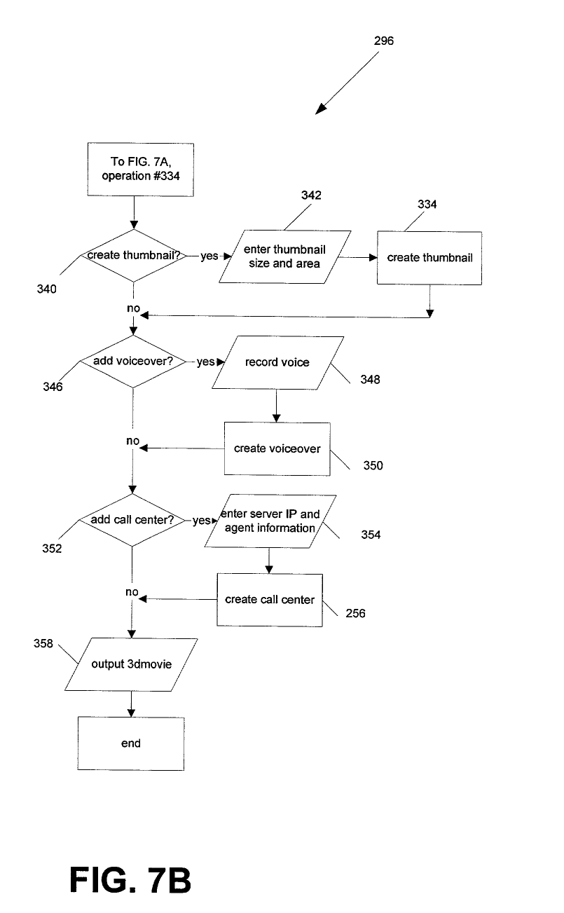

FIG. 7A illustrates a flow diagram of the 3-D movie builder module according to one embodiment of the present invention. The 3-D builder module 296 is used to create 3-D movies. For example, the 3-D movie builder may be used to display a rotating object to allow the client 102 to view the object from every angle of view. The user interface of the 3-D movie builder 296 described herein acts as the front-end interface to one 3-D movie builder program. There are several commercially available 3-D movie builder programs. The general functions and features of the various 3-D movie builder programs are very similar and it should be apparent to one skilled in the art that the user interface may have to be modified to accommodate for the differences between various 3-D movie builder programs.

The operation of the 3-D movie builder 296 starts with opening an image source in step 298. Similar to the panorama view builder 156, the image source for the 3-D movie builder 296 may be created in a plurality of ways. The images may be scanned into a computer and converted into digital format or they may be created and directly downloaded from a digital camera.

In operation 300, the user may select the option of changing and readjusting the orientation of the digital images. Once the user has selected this option, the 3-D movie builder changes the orientation of selected individual image frame. In operation 304, the user may elect to adjust the image source color. In operation 305, the user enters brightness and contrast values for the image. In operation 306, the system adjusts the image based on the user entered values and presents the image to the user for his approval in operation 304. The user may continue readjusting the image and viewing it until he is satisfied with the color.

In operation 307, the user may delete portions of the image by cutting and cropping. Cutting allows the user to select an area to be deleted and cut that area from the panorama view. Cropping would allow the user to define a border above or below which the image is cutoff. Cutting or cropping is done by selecting an area to cut or crop in step 308. The system next cuts or crops the selected area and creates the image in operation 309. The user is given the option of accepting or rejecting the changes in operation 307.

In operation 310, the user is given the option of adjusting the image size. If the user elects to change the image size, he may enter a desired image height in step 311. The 3-D movie builder 296 then resizes the image in step 312 and the system asks the user in step 308 if the resized image is acceptable. The image size may be readjusted until the user is satisfied.

In step 314, the user may preview the 3-D movie created from the image source. In step 316, the user has the option of changing the active frame file size. A 3-D movie consists of several frames with different viewing angles. Each frame is an image. The active frame is the image user are previewing and editing with the builder.

If the user selects this option in operation 316, he is then required to provide the system with a target file size in operation 318. In operation 320, based on the user input, the 3-D movie builder 296 attempts to compress the file size to the extent desired. In operation 322, the image quality has to be accepted by the user. If the image quality is not acceptable to the user, the 3-D movie builder 296 may perform steps 318 through 322 to adjust the file size until the desired balance between quality and file size is reached. If the desired reduction in the file size is not possible, the system would compress the file to the extent possible and ask the user to approve the file size. Alternatively, the system may inform the user that the desired file size reduction is not possible and request the user to enter a new value for the file size reduction. The reduction of the file size by compression results in image quality degradation.

Once the user is satisfied with the quality of the image after the file size reduction, the reduction is applied to all frames of the image source, in operation 324. In operation 326, the user may elect to add embedded text to the 3-D movie. Upon this selection, the 3-D movie builder module 296 prompts the user to enter a text position, content and URL link for the embedded text in operation 330. The 3-D movie builder 296 then proceeds to create the embedded text in operation 332. Operations 326-332 are repeated until the user has input all the embedded text he desires.

In operation 334, the user may elect to add magnifier features to the 3-D movie. I In operation 336, if the user elects to add magnifying details, the user may enter a magnification factor as well as the frame number the magnification factor applies to. In operation 338, the 3-D movie builder 296 uses this magnification factor to create a magnifier. A magnifier as used herein refers to creating a magnified image of a user-selected frame of the 3-D movie. Operations 334 through 338 may be repeated if the user elects to add magnifying details on additional frames.

Additional features of the 3-D movie builder 296 are described in FIG. 7B.

FIG. 7B illustrates the continuation of the flow diagram of the 3-D movie builder module according to one embodiment of the present invention As shown in FIG. 7A of flow diagram of one embodiment of the 3-D movie builder 296, after deciding on the option to create a magnified view, in operation 334, the user may elect to create a thumbnail for the 3-D movie in operation 340.

In operation 340, the user may elect to create a thumbnail. A thumbnail as used herein refers to a small image created to represent the 3-D movie. The thumbnail may be used in a catalog display by showing the actual view presented to the client if he selects that particular thumbnail. In operation 342, if the user elects to create a thumbnail, he may enter the values for the size and the area of panorama image to be included in the thumbnail. In operation 344 the 3-D movie builder 296 creates the thumbnail.

The user may further decide to add voiceover to the 3-D movie, he can input the voiceover by recording it in operation 348. In operation 350, the 3-D movie builder 296 proceeds to create the voiceover.

In operation 352, the user may elect to add call center features to the 3-D movie. If the user elects to call center features to the 3-D movie, he may enter the agent information including the Internet address or IP address of the server that is connecting that agent or group of agents to the Internet and ultimately the clients in operation 354. In operation 356, the 3-D movie builder 296 creates call center. This step includes adding the call center control bar 152 as described in FIG. 3. The process of creating a 3-D movie is completed in operation 358 by outputting a 3-D movie file. The file may include a series of HTML files with embedded Java Applets.

In one embodiment of the present invention, the 3-D movie file is stored on a the user's file server, and the user provided services include creating the 3-D movie as well as hosting the web site and the files for a third party customer. The potential clients 102 would be accessing the servers of the service provider that has created the 3-D movie to access the information and images residing therein.

In an alternative embodiment, the 3-D movie builder module 296 may be used as a stand alone module that allows any user to create 3-D movie files that may be stored on that user's own web site or a third party web site. Thus, the seller of the 3-D movie builder module 296 would not necessarily provide the associated services of hosting the web site of the user and providing associated services such as the call center system 120.

The process described herein is the implementation of one embodiment of 3-D movie builder 296. It would be apparent to one skilled in the art that the operations comprising this process may be performed in a different order.

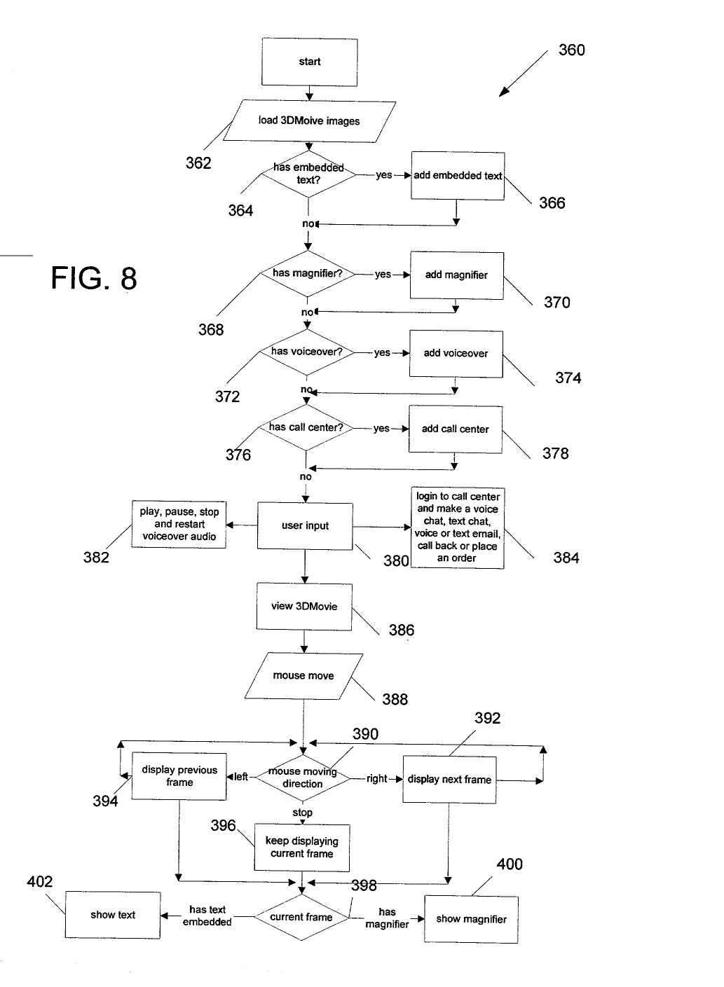

FIG. 8 illustrates a flow diagram of one embodiment of a 3-D movie viewer module. The 3-D movie viewer 360 is used by clients 102 to view the 3-D movies created by the 3-D movie builder module 296, and stored on a web site. The operation of the 3-D movie viewer 360 begins with loading the 3-D movie in operation 362. Once the 3-D movie viewer 360 has loaded the 3-D movie, it looks for embedded text features, in operation 364. If embedded text is present, the 3-D movie viewer 360 adds the embedded text in operation 366.

In operation 368, the 3-D movie viewer 360 checks for the presence of magnified views of the 3-D movie image. If magnified views are present, the 3-D movie viewer 360 adds the partially magnified images on the top of the 3-D movie images, in operation 370.

In operation 372, the 3-D movie viewer 360 determines whether the panorama image includes any voiceover. If voiceover is included, the 3-D movie viewer 360 adds voiceover to the image in operation 374.

In operation 376, the 3-D movie viewer 360 determines if call center features were included with the 3-D movie. In operation 378, the call center features are added to the 3-D movie.

In operation 380, the 3-D movie viewer 360 determines the user input. The user in this case would be the client 102 who are using the 3-D movie viewer 360 to view 3-D movies stored on a server. The client input may control the voiceover audio playing in operation 382. Alternatively, in operation 384, the client input may trigger a login to the call center and establishment of communication with an available agent via a communication mode selected by the client. In operation 386, the 3-D movie is presented to the user.

In operation 388, the motion of the client's mouse are obtained. The direction of motion for the client mouse is used to control the playing of the 3-D movie in operation 390. In operation 392, if the direction of the motion of the mouse is to the right, the 3-D movie viewer displays the next frame of the 3-D movie. Alternatively, in operation 394, if the motion of the client mouse is to the left, the 3-D movie viewer 360 displays the previous frame of the 3-D movie. In operation 396, if the mouse stops, the 3-D movie viewer 360 keeps displaying the current frame.

In operation 398, the 3-D movie viewer determines if the current frame has embedded text or magnifier associated with it. If the current frame has magnified details associated with it, the 3-D movie viewer would show the magnified view, in operation 400. If the current frame has embedded text associated with it, the 3-D movie viewer would display the embedded text in operation 402.

This intuitive user interface is used to control the display the 3-D movie file. It would be apparent to one skilled in the art that alternative means of controlling the displaying of the 3-D movie may be used to perform a similar operations.

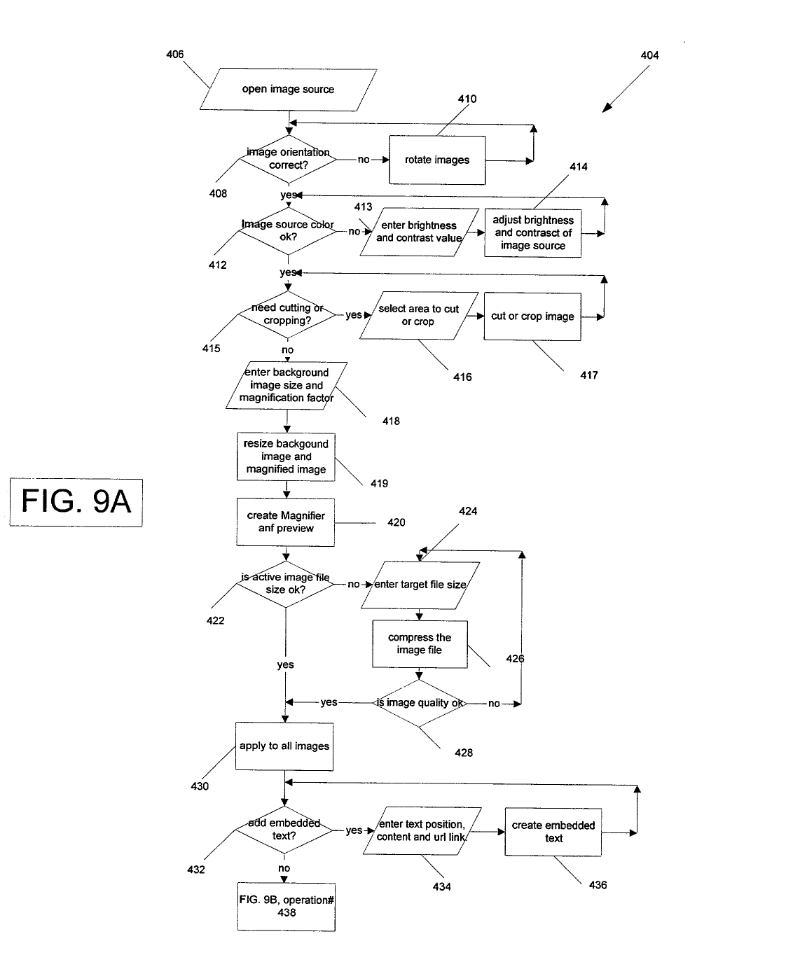

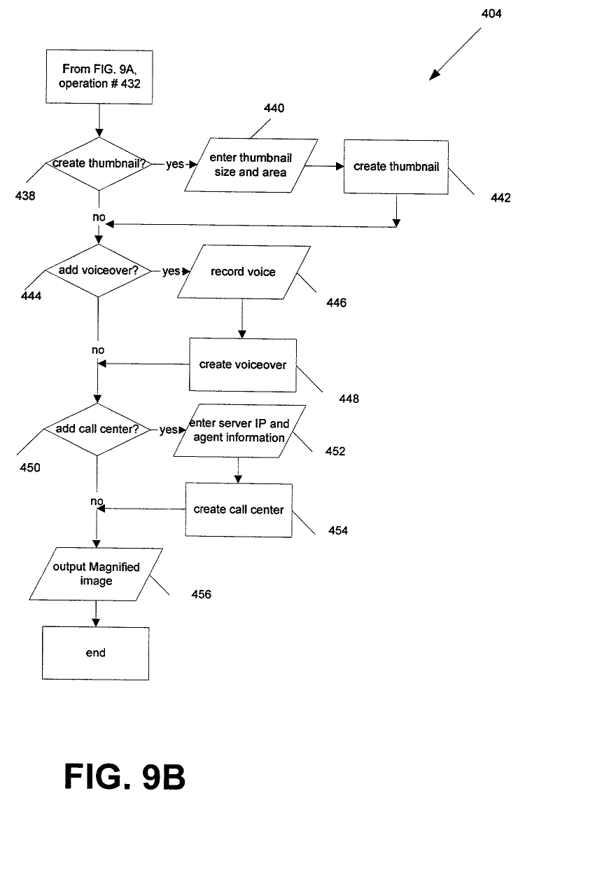

FIG. 9A illustrates a flow diagram of the magnifier builder module according to one embodiment of the present invention. The magnifier builder module 404 is used to create magnified images of a selected frame. The user interface of the magnifier builder module 404 described herein may act as a front-end interface to several commercially available magnifier view creation programs, with slight modifications.

The process of creating a magnified view starts with opening an image source in step 406. Similar to the panorama view builder 156, the image source for the magnifier builder 404 may be created in a plurality of ways. The images may be scanned into a computer and converted into digital format or they may be created and directly downloaded from a digital camera.

In operation 408, the user may select the option of changing and readjusting the orientation of the incoming digital images. Once the user has selected this option, the magnifier builder rotates the selected image frame in operation 410.

In operation 412, the user may adjust the color of the image source. If the user decides to change the image color, he may enter values for the brightness and contrast in operation 413. The system uses the user entered valued to adjust the image for brightness and contrast in operation 414. The user has may accept or reject these changes in operation 412 until he is satisfied with the image color.

In operation 415, the user may delete portions of the image by cutting and cropping. Cutting allows the user to select an area to be deleted and cut that area from the panorama view. Cropping would allow the user to define a border above or below which the image is cutoff. Cutting or cropping is done by selecting an area to cut or crop in step 416. The system next cuts or crops the selected area and creates the image in operation 417. The user is given the option of accepting or rejecting the changes in operation 415.

In operation 418, the user enters the background image size and the magnification factor for the magnified image. In operation 419, the magnifier builder 404 resizes the background image and the magnified image. In operation 420, the magnified image is created and displayed for the user preview.

In operation 422, the user has the option of changing the image file size. If the user selects this option, he is then requested to provide the magnifier builder module with a target file size in operation 424. In operation 426, based on the user input, the magnifier builder 404 attempts to compress the file size to the extent desired. In operation 428, the user is asked to accept the image quality. If the image quality is not acceptable to the user, the magnifier builder 404 may perform steps 424 through 428 to adjust the file size until the desired balance between quality and file size is reached. If the desired reduction in the file size is not possible, the system would compress the file to the extent possible and ask the user to approve the file size. Alternatively, the system may inform the user that the desired file size reduction is not possible and request the user to enter a new value for the file size reduction. The reduction of the file size by compression results in image quality degradation. Once the user is satisfied with the quality of the image after the file size reduction, the reduction is applied to all frames of the image source, in operation 430. It should be noted that a 3-D movie consists of several frames with different viewing angles and each frame is an image.

In operation 432, the user may elect to add embedded text to the magnified image. Upon this selection, the magnifier builder module 404 prompts the user to enter a text position, content and URL link for the embedded text in operation 434. The magnifier builder 404 then proceeds to create the embedded text in operation 436. Operations 432-436 may be repeated until the user has input all the embedded text desired.

Additional features of the 3-D movie builder 404 are described in FIG. 9B.

FIG. 9B illustrates the continuation of the flow diagram of the magnifier builder module, according to one embodiment of the present invention. As shown in FIG. 9A of flow diagram of one embodiment of the magnifier builder 404, after deciding on the option to add embedded text, in operation 432, the user may elect to create a thumbnail, in operation 438.

In operation 438, the user may elect to create a thumbnail. A thumbnail as used herein refers to a small image created to represent the particular image represented by the thumbnail. A thumbnail may be used in a catalog display by showing the actual view presented to the client if he selects that particular thumbnail. In operation 440, if the user elects to create a thumbnail, he may enter the values for the size and the area of magnified image to be included in the thumbnail. In operation 442 the magnifier builder 404 creates the thumbnail.

The user may further add voiceover to the magnified view. He may input the voiceover by recording it in operation 446. In operation 448, the magnifier builder 404 proceeds to create the voiceover.

In operation 450, the user may elect to add call center features to the magnified view. If the user elects to call center features to the magnified view, he may enter the agent information including the Internet address or IP address of the server that is connecting that agent or group of agents to the Internet and ultimately the clients in operation 452. In operation 454, the magnifier builder 404 creates call center. This step includes adding the call center control bar 152 as described in FIG. 3. The process of creating a magnified view is completed in operation 456 by outputting a magnified view file. The file may include a series of HTML files, JPG images with embedded Java Applets. The 3-D movie, magnifier and panorama viewer programs are using Java Applets with the standard classes which are pre-installed on the web browsers across platforms and thus require no plug-in program to be downloaded.

In one embodiment of the present invention, the magnified view file is stored on a the user's file server, and the user provided services include creating the magnified view as well as hosting the web site and the files for a third party customer. The potential clients 102 would be accessing the servers of the service provider that has created the magnified image to access the information and images residing therein.

In an alternative embodiment, the magnifier builder module 404 may be used as a stand alone module that allows any user to create magnified view files that may be stored on that user's own web site or a third party web site. Thus, the seller of the magnifier builder module 404 would not necessarily provide the associated services of hosting the web site of the user and providing associated services such as the call center system 120.

The process described herein is the implementation of one embodiment of magnifier builder 404. It would be apparent to one skilled in the art that the operations comprising this process may be performed in a different order.

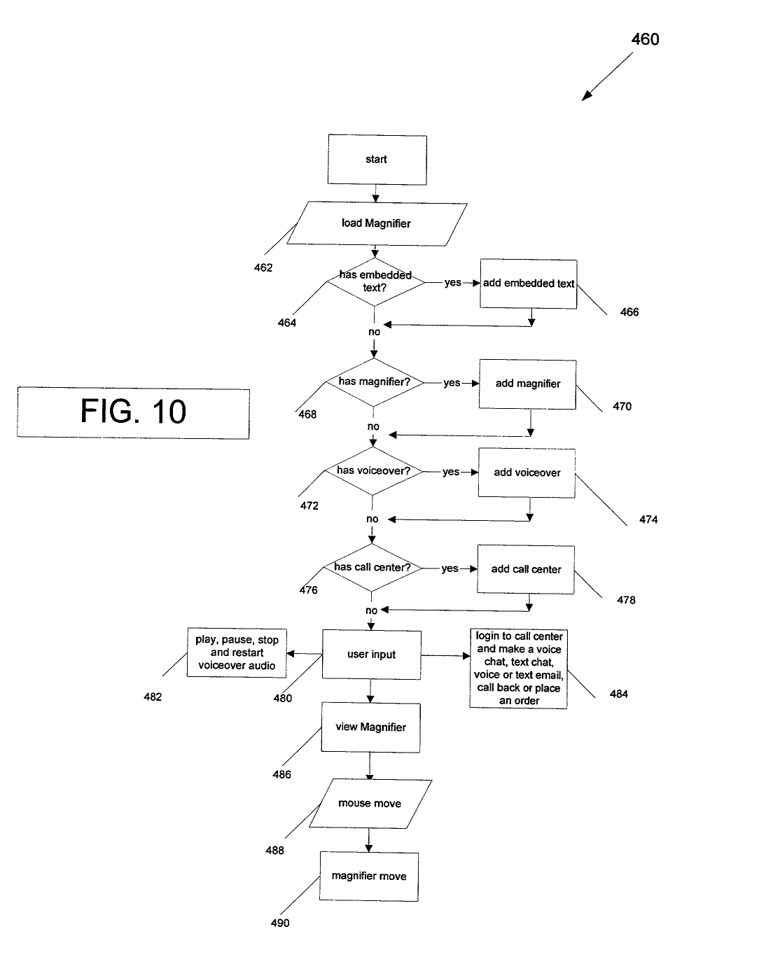

FIG. 10 illustrates a flow diagram of one embodiment of a magnifier viewer module. The magnifier viewer 460 is used by clients 102 to view the objects that include a magnified view, created by the magnifier builder module 404, and stored on a web site. The operation of the magnifier viewer 460 begins with loading the magnified view file, in operation 462. Once the magnifier viewer 460 has loaded the magnified view file, it looks for embedded text features, in operation 464. If embedded text is present, the magnifier viewer adds 460 the embedded text in operation 466.

In operation 468, the magnifier viewer 460 checks for the presence of magnified views of the magnified image. If magnified views are present, the magnifier viewer 460 adds the partially magnified images on the top of background images, in operation 470.

In operation 472, the magnifier viewer 460 determines whether the magnified view includes any voiceover. If voiceover is included, the magnifier viewer 460 adds voiceover to the image in operation 474.

In operation 476, the magnifier viewer 460 determines if call center features were included with the magnified view. In operation 478, the call center features are added to the magnified view.

In operation 480, the magnifier viewer 460 determines the user input. The user in this case would be the client 102 who are using the magnifier viewer 460 to view magnified views stored on a server. The client input may control the voiceover audio playing in operation 482. Alternatively, in operation 484, the client input may trigger a login to the call center and establishment of communication with an available agent via a communication mode selected by the client.

In operation 486, the magnified view is displayed. In operation 488, the motion of the client 102 mouse are determined. In operation 490, the motion of the mouse is replicated by moving the magnifier in the same direction as the client 102 mouse moves, over the background image.

This intuitive user interface is used to control the display the magnified view files. It would be apparent to one skilled in the art that alternative means of controlling the displaying of the magnified view files may be used to perform a similar operations.

The foregoing examples illustrate certain exemplary embodiments of the invention from which other embodiments, variations, and modifications will be apparent to those skilled in the art. The invention should therefore not be limited to the particular embodiments discussed above, but rather is defined by the following claims.

### INDUSTRIAL APPLICABILITY

The present invention method 100 and system 101 are well suited for application in web design and creation of online interactive systems allowing.

Web based systems are still unable to provide a realistic, life like interactive environment for a client and service provider. In a real retail environment, the client can inspect the product, look at it from different angles, and simultaneously ask questions of a salesperson helping him or her out about the product. The salesperson can suggest other products that may satisfy the need of the client. It is desirable to provide this realistic interactive environment to mimic the real life experience of a client as closely as possible.

Existing systems are of poor quality, and do not allow for simultaneous, clear bi-directional transmission. No existing system has combined voice technology with still and streaming images in addition to text interactivity, in the context of providing a realistic interactive environment, providing a closely realistic experience.

Therefore, it is desirable to provide an improved method and system capable of supporting online sales, business transactions, conferences and educational settings, wherein the user experience is improved, both in terms of customer service and in terms of communication technology.

Briefly, a first embodiment of the present invention comprises of a method of providing a real time interactive environment, over the Internet, between an agent of an online retailer and a client, comprising, creating images of a product of the online retailer, the images including at least one of a panorama view image, a 3-D movie and a magnified image frame, providing a call center services for real time, bi-directional communication between the agent and the client, combining the product image with recorded voiceover, the voiceover further describing the product, providing means by which the agent can push onto the client computer an alternative product, wherein the agent and the client view the alternative product simultaneously, providing means for the retailer to receive client input, and providing a web server for hosting the created image of the product of interest and hosting the call center.

A second embodiment the present invention is embodied in a method and tool for providing a real time interactive environment, over the Internet, between an agent and a client, comprising, creating images of a product, the images including at least one of a panorama view image, a 3-D movie and a magnified image frame, providing a call center services for real time, bi-directional communication between the agent and the client, combining the product image with recorded voiceover, the voiceover further describing the product, providing means by which the agent can push onto the client computer an alternative product, wherein the agent and the client view the alternative product simultaneously, and providing means for receiving client input.

A third embodiment of the present invention is a method and tool for creating a panorama image comprising, obtaining digital photos from an image source, stitching digital photos to create a panorama image, cutting and/or cropping the image, adjusting the image for contrast and brightness, compressing the panorama image, recording voiceover related to the panorama image, and associating the panorama image with a call center module, wherein the call center provides bi-directional, real time communication between an agent and a client viewing the panorama image.

Another embodiment of the present invention is a method and tool for creating a 3-D movie comprising, obtaining a plurality of digital photos from an image source, combining the plurality of digital photos to create a 3-D movie, cutting and/or cropping the image, adjusting the image for contrast and brightness, compressing the 3-D movie, recording voiceover related to at least one frame of the 3-D movie, and associating the 3-D movie with a call center module, wherein the call center provides bi-directional, real time communication between an agent and a client viewing the 3-D movie.

Yet another embodiment of the present invention is a method and tool for creating a magnified view of an image frame comprising, obtaining a digital photo from an image source corresponding to a selected image frame, obtaining a user input defining a background image size and a magnified image size, creating a magnified image corresponding to the selected image frame, cutting and/or cropping the image, adjusting the image for contrast and brightness, compressing the magnified image file, combining the selected image frame with recorded voiceover, and associating the selected image with a call center module, wherein the call center provides bi-directional, real time communication between an agent and a client viewing the selected image frame.

For the above, and other, reasons, it is expected that the present invention method 100 and system 101 will have widespread industrial applicability. Therefore, it is expected that the commercial utility of the present invention will be extensive and long lasting.

We claim:

1. A method of providing a real time interactive environment, over the Internet, between an agent of an online retailer and a client, comprising:
creating images of a product of the online retailer, the images including at least one of a panorama view image, a 3-D movie image and a magnified image frame;
providing call center services for real time, bi-directional communication between the agent and the client,
combining the product image with recorded voiceover, the voiceover further describing the product;
pushing onto the client computer an alternative product, wherein the agent and the client view the alternative product simultaneously;
receiving client input; and
providing a web server for hosting the created image of the product of interest and hosting the call center.

2. The method of claim 1 wherein the client input include a product purchase order. further comprising:

3. The bi-directional communication means of claim 1 comprising one of voice chat, text chat, voice email, text email, group chat and shopping cart.

4. A method of providing a real time interactive environment, over the Internet, between an agent and a client, comprising:
creating images of a product, the images including at least one of a panorama view image, a 3-D movie and a magnified image frame;
providing a call center services for real time, bi-directional communication between the agent and the client,
combining the product image with recorded voiceover, the voiceover further describing the product;
pushing onto the client computer an alternative product, wherein the agent and the client view the alternative product simultaneously; and
receiving client input.

5. The method of claim 4 wherein the client input include a product purchase order. further comprising:

6. The bi-directional communication means of claim 4 comprising one of voice chat, text chat, voice email, text email, group chat and shopping cart.

7. A method of creating a panorama image comprising:
obtaining digital photos from an image source;
stitching digital photos to create a panorama image;
compressing the panorama image;
recording voiceover related to the panorama image; and
associating the panorama image with a call center module, wherein the call center provides bi-directional, real time communication between an agent and a client viewing the panorama image.

8. The method of claim 7 providing communication means including one of: voice chat, text chat, voice email, text email, group chat and shopping cart.

9. The method of claim 7 further comprising:
adding embedded text to the panorama image.

10. The method of claim 7 further comprising:
adding magnifier view to the panorama image.

11. The method of claim 7 further comprising:
creating a thumbnail view to the panorama image.

12. The method of claim 7 further comprising:
performing at least one of cutting, cropping, adjusting color and resizing the panorama image.

13. A method of creating a 3-D movie comprising:
obtaining a plurality of digital photos from an image source;
combining the plurality of digital photos to create a 3-D movie;
compressing the 3-D movie;
recording voiceover related to at least one frame of the 3-D movie; and
associating the 3-D movie with a call center module, wherein the call center provides bi-directional, real time communication between an agent and a client viewing the 3-D movie.

14. The method of claim 13 providing communication means including one of: voice chat, text chat, voice email, text email, group chat and shopping cart.

15. The method of claim 13 further comprising:
adding embedded text to the 3-D movie.

16. The method of claim 13 further comprising:
adding magnifier view to an image frame of the 3-D movie.

17. The method of claim 13 further comprising:
creating a thumbnail view to the 3-D movie.

18. The method of claim 13 further comprising:
performing at least one of cutting, cropping, adjusting color and resizing the 3-D movie.

19. A method of creating a magnified view of an image comprising:
obtaining a digital photo from an image source;
obtaining a user input defining a background image size and a magnified image size;
creating a magnified image corresponding of at least a part of the background image frame;
combining an image file comprising of the magnified image and the background image with recorded voiceover; and
associating the image file with a call center module, wherein the call center provides bi-directional, real time communication between an agent and a client simultaneously viewing the image file.

20. The method of claim 19 providing communication means including one of: voice chat, text chat, voice email, text email, group chat and shopping cart.

21. The method of claim 19 further comprising:
adding embedded text to the magnified image.

22. The method of claim 19 further comprising:
creating a thumbnail view to the magnifier image.

23. The method of claim 19 further comprising:
performing at least one of cutting, cropping, adjusting color and resizing the magnifier image.

24. A system for providing a real time interactive environment, over the Internet, between an agent of an online retailer and a client, comprising:
means for creating images of a product of the online retailer, the images including at least one of a panorama view image, a 3-D movie and a magnified image frame;
means for providing a call center services for real time, bi-directional communication between the agent and the client,
means for combining the product image with recorded voiceover, the voiceover further describing the product;
means for providing means by which the agent can push onto the client computer an alternative product, wherein the agent and the client view the alternative product simultaneously;
means for providing means for the retailer to receive client input; and
means for providing a web server for hosting the created image of the product of interest and hosting the call center.

25. A system for providing a real time interactive environment, over the Internet, between an agent and a client, comprising:
means for creating images of a product, the images including at least one of a panorama view image, a 3-D movie and a magnified image frame;
means for providing a call center services for real time, bi-directional communication between the agent and the client,
means for combining the product image with recorded voiceover, the voiceover further describing the product;
means for providing means by which the agent can push onto the client computer an alternative product, wherein the agent and the client view the alternative product simultaneously; and
means for providing means for receiving client input.

26. A computer program product embodied in a computer readable medium for creating a panorama image comprising:
code means for obtaining digital photos from an image source;
code means for stitching digital photos to create a panorama image;
code means for compressing the panorama image;
code means for recording voiceover related to the panorama image; and
code means for associating the panorama image with a call center module, wherein the call center provides bi-directional, real time communication between an agent and a client viewing the panorama image.

27. A computer program product embodied in a computer readable medium for creating a 3-D movie comprising:
code means for obtaining a plurality of digital photos from an image source;
code means for combining the plurality of digital photos to create a 3-D movie;
code means for compressing the 3-D movie;
code means for recording voiceover related to at least one frame of the 3-D movie; and
code means for associating the 3-D movie with a call center module, wherein the call center provides bi-directional, real time communication between an agent and a client viewing the 3-D movie.

28. A computer program product embodied in a computer readable medium for creating a magnified view of an image frame comprising:
code means for obtaining a digital photo from an image source corresponding to a selected image frame;
code means for obtaining a user input defining a background image size and a magnified image size;
code means for creating a magnified image corresponding to the selected image frame;
code means for combining the selected image frame with recorded voiceover; and
code means for associating the selected image with a call center module, wherein the call center provides bi-directional, real time communication between an agent and a client viewing the selected image frame.
